(19) United States
(12) Patent Application Publication
(10) Pub. No.: US 2008/0306666 A1
(43) Pub. Date: Dec. 11, 2008

(54) Method and apparatus for rear cross traffic collision avoidance

(75) Inventors: Shuqing Zeng, Sterling Heights, MI (US); Jeremy A. Salinger, Southfield, MI (US); Prasanna Vignesh V. Ganesan, Chennai (IN)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/758,187

(22) Filed: Jun. 5, 2007

(51) Int. Cl. G08G 1/16; G05D 13/00; G06F 19/00

(52) U.S. Cl. 701/70; 701/301

(57) ABSTRACT

A rear cross-traffic collision avoidance system that provides a certain action, such as a driver alert or automatic braking, in the event of a collision threat from cross-traffic. The system includes object detection sensors for detecting objects in the cross-traffic and vehicle sensors for detecting the vehicle turning. A controller uses the signals from the object detection sensors and the vehicle sensors to determine and identify object tracks that may interfere with the subject vehicle based on the vehicle turning.

### BACKGROUND OF THE INVENTION

1. Field of the Invention

This invention relates generally to a rear cross-traffic collision avoidance (RCTCA) system and, more particularly, to an RCTCA system that determines whether cross-traffic may cause a collision threat, and if so, take appropriate action.

2. Discussion of the Related Art

Various types of safety systems are known in the art for protecting the occupants of a vehicle in the event of a collision. Some of these systems attempt to prevent the collision before it occurs by warning the vehicle operator of a potential collision situation. For example, a forward collision warning system (FCW) may employ a forward-looking laser or radar device that alerts the vehicle driver of a potential collision threat. The alerts can be a visual indication on the vehicle's instrument panel or a head-up display (HUD), and/or can be an audio warning or a vibration device, such as a HAPTIC seat. Other systems attempt to prevent a collision by directly applying a braking action if the driver fails to respond to an alert in a timely manner.

### SUMMARY OF THE INVENTION

In accordance with the teachings of the present invention, a rear cross-traffic collision avoidance system for a subject vehicle is disclosed that provides a certain action, such as a driver alert or automatic braking, in the event of a collision threat from cross-traffic. The system includes object detection sensors for detecting objects, such as vehicles, and providing object sensor signals, and vehicle sensors for sensing vehicle turning conditions in the subject vehicle and providing vehicle sensor signals. The system also includes an object tracking and classification processor responsive to the object sensor signals that identifies and tracks objects that potentially may interfere with the subject vehicle. The system also includes a host vehicle path prediction processor responsive to the vehicle sensor signals that provides path curvature signals indicating the curvature of the path of the subject vehicle as it moves in reverse. The system also includes a target selection processor that selects potential objects that may be in a collision path with the subject vehicle. The system also includes a threat assessment processor that determines whether action should be taken to avoid a collision with an object.

Additional features of the present invention will become apparent from the following description and appended claims taken in conjunction with the accompanying drawings.

### BRIEF DESCRIPTION OF THE DRAWINGS

FIG. 1 is a diagram showing a possible vehicle collision situation as a result of a vehicle backing into cross-traffic;

FIG. 2 is a block diagram showing a rear cross-traffic collision avoidance system, according to an embodiment of the present invention;

FIG. 3 is a bicycle model of a vehicle showing variables used in the calculation of vehicle motion;

FIG. 4 is a flow chart diagram showing a process for sensor fusion, according to an embodiment of the present invention;

FIG. 5 is a plant model of the dynamic motion between a subject vehicle and a target vehicle;

FIG. 6 is a diagram showing a plot of a vehicle in world coordinates backing out of a parking space;

FIG. 7 is a plot showing a vehicle in a vehicle coordinate system backing out of a parking space;

FIG. 8 is a plan view showing escape paths for a target vehicle; and

FIG. 9 is a state transition diagram for the RCTCA system of the invention.

### DETAILED DESCRIPTION OF THE EMBODIMENTS

The following discussion of the embodiments of the invention directed to a rear cross-traffic collision avoidance system is merely exemplary in nature, and is in no way intended to limit the invention or its applications or uses. For example, the discussion below particularly refers to a vehicle backing out of a parking space. However, as will be appreciated by those skilled in the art, the present invention will have application for other driving situations.

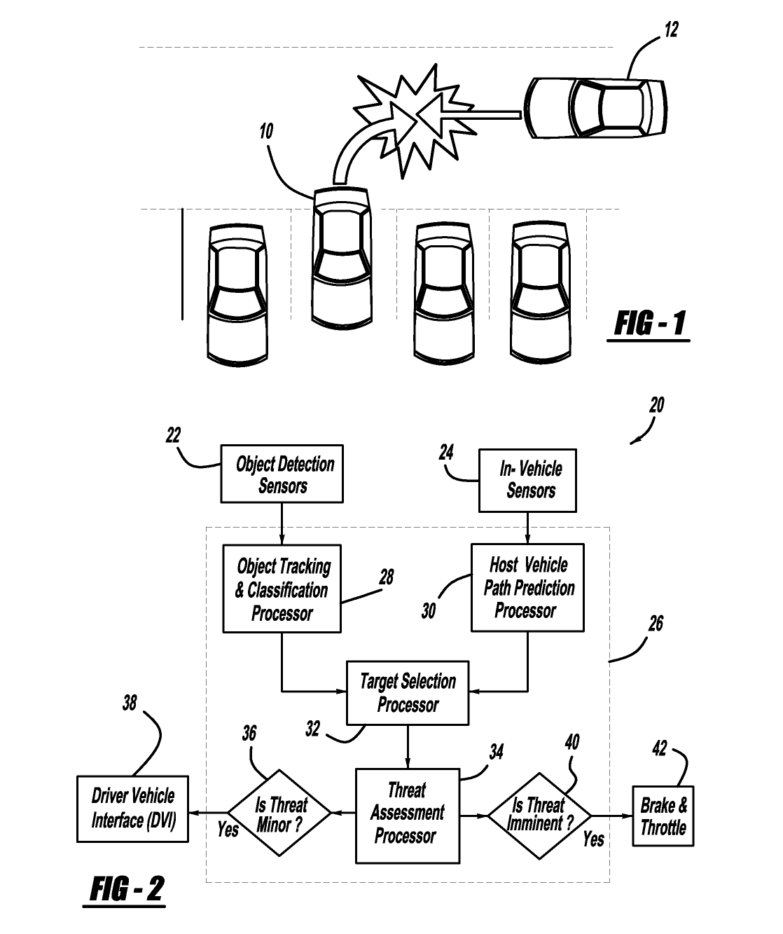

The present invention proposes a rear cross-traffic collision avoidance (RCTCA) system that assists a vehicle driver in avoiding conflicts with cross-traffic approaching from either side when backing out a parking space at slow speeds by providing warnings and possibly automatically applying the brakes to the vehicle. FIG. 1 is an illustration of the type of potential collision situation that the RCTCA system of the invention is attempting to prevent. In this illustration, a subject vehicle 10 is shown backing out from a parking space into cross-traffic in front of a target vehicle 12.

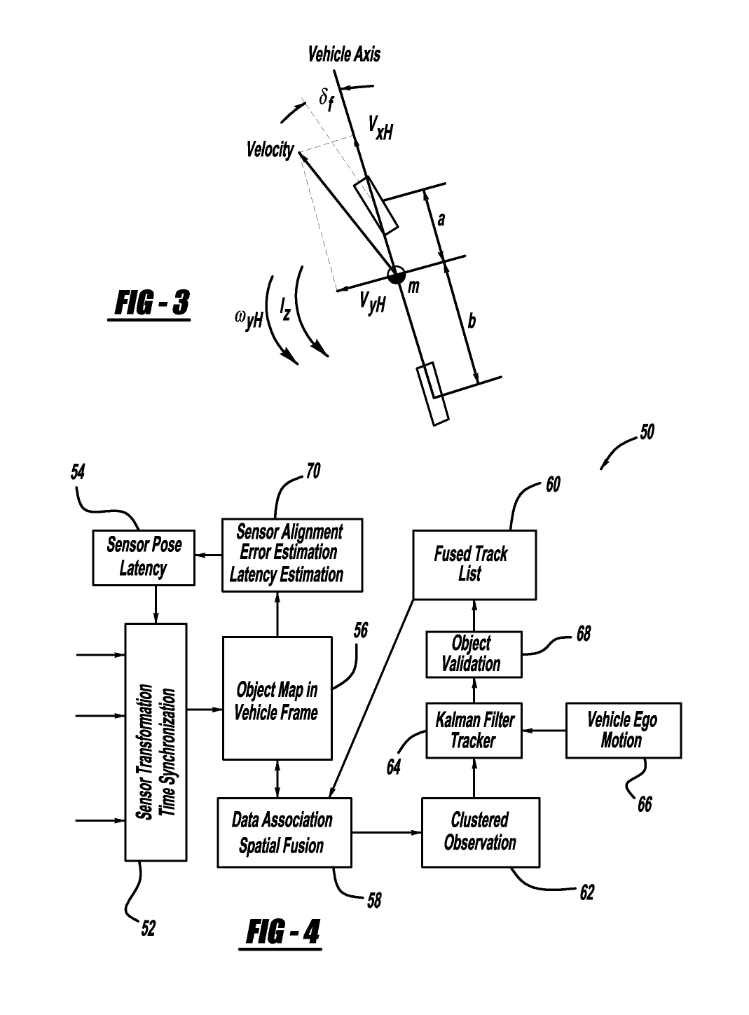

FIG. 2 is a block diagram of an RCTCA system 20 of the invention. The system 20 includes object detection sensors 22 that can report an object's position and speed, such as a 24 GHz ultra-wide band radar and/or camera system, with object detection capability. The object detection sensors 22 will typically be at the rear and sides of the vehicle. The system also includes in-vehicle sensors 24 that can identify the turning rate of the vehicle, such as steering wheel angle sensors, yaw rate sensors, etc. Sensor signals from the object detection sensors 22 and the in-vehicle sensors 24 are sent to a system processing unit 26 that processes the sensor data.

The signals from the object detection sensors 22 are sent to an object tracking and classification processor 28 that identifies one or more potential targets, and provides tracking of the targets, such as location, direction, range, speed, etc. of the target. Object tracking and classification systems that perform this function are well known to those skilled in the art. The object tracking and classification processor 28 integrates the object maps from different sensors, merges multiples measurements from the same object into a single measurement, tracks the object, such as by using Kalman filters, across consecutive time frames, and generates a fused object list in the vehicular frame. The in-vehicle sensor signals from the vehicle sensors 24 are sent to a host vehicle path prediction processor 30 that uses the vehicle sensor signals to provide an indication of the curvature of the path of the subject vehicle 10 as it is backing from the parking space.

The target tracking signals from the processor 28 and the path of the subject vehicle 10 from the processor 30 are sent to a target selection processor 32 that chooses potential objects that may be in a collision path with the subject vehicle 10 from the fused object list, as will be discussed in detail below.

The selected targets that may be on a potential collision course with the subject vehicle 10 are sent to a threat assessment processor 34 that employs decision logic that takes the selected in-path objects to determine whether a potential collision exists, whether an alert should be given, whether the vehicle brakes should be applied, etc., as will also be discussed in detail below. The threat assessment processor 34 will determine whether the threat is minor at decision diamond 36, and if so will send a signal to a driver vehicle interface device 38 that will provide some type of warning, such as an audible warning, a visual warning, a seat vibration, etc., to the driver. The threat assessment processor 34 will also determine if a potential collision is imminent at decision diamond 40, and if so, cause the vehicle brakes to be applied and the vehicle throttle to be disabled at box 42.

The vehicle path prediction processor 30 models the vehicle as a bicycle model represented by a motion vector u_{H} with components of yaw rate ω_{H}, longitudinal speed υ_{χH} and lateral speed υ_{yH}. FIG. 3 is an illustration of a bicycle model of the subject vehicle 10 showing the various parameters of motion. The in-vehicle sensors 24 give measurements of vehicle speed υ_{χo}, lateral acceleration a_{yo} and angular velocity ω_{Ho}. The steering wheel angle sensor gives the front wheel angle δ_{f}. Because the RCTCA system 20 usually operates at low-speed conditions with a large front-wheel angle, a kinematic constraint to correct the measured yaw rate ω_{Ho} is used. It is assumed that the correction δ_{ωH} is a random walk process so that the plant model can be written as:

δω_{H}(t+1)=δω_{H}(t)+∈ (1)

Where ∈ is a zero-mean Gaussian white noise process.

The observation equations can be written as:

$$\begin{matrix}\frac{tan {δ}_{f}}{a + b} {υ}_{xo} = {ω}_{Ho} + δ {ω}_{H} + {v}_{1} & ( 2 ) \\ {a}_{yo} = ( {ω}_{Ho} + δ {ω}_{H} ) {υ}_{xo} + {v}_{2} & ( 3 )\end{matrix}$$

Where ν₁ and ν₂ are measurement noise modeled as zero-mean white Gaussian random processes.

A Kalman filter is used to estimate the correction δω_{H}. Then, the motion vector u_{H} can be calculated as:

υ_{xH}=υₓₒ (4)

ω_{H}=ω_{Ho}+δω_{H} (5)

υ_{yH}=bω_{H} (6)

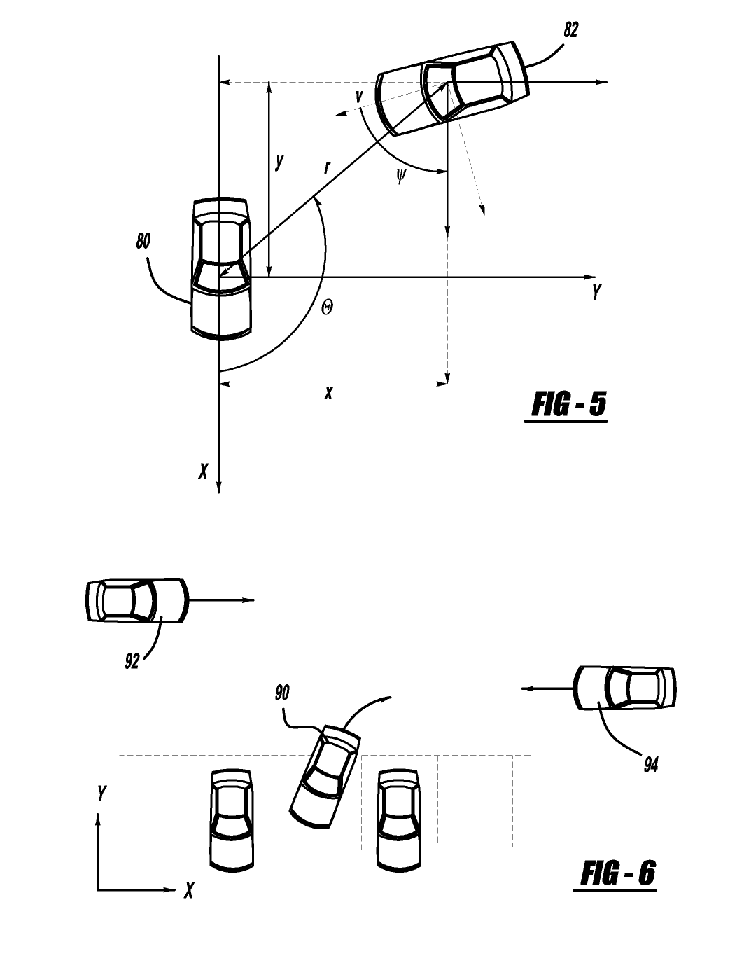

FIG. 4 is a block diagram 50 showing the fusion process in the object tracking and classification processor 28. The fusion process assumes that observations are processed sequentially, and begins with the acquisition of the observations from the individual sensors 22. A sensor transformation time synchronization processor 52 receives the several sensor signals from the object detection sensors 22 and sensor pose and latency from box 54, and transforms the object maps from the individual sensors 22 into a unified object map in the vehicle frame at box 56 based on the estimated pose and the latency of each sensor 22. The object map is applied to a data association and spatial fusion process at box 58 that compares the unified object map against known entities provided by a fused track list 60. The observations may represent the observed position of an entity, such as range, azimuth and range rate, and identity information and parameters that can be related to identify the entity, such as confidence level, tracking maturity and geometric information of the entity. The data association process systematically compares observations against the known fused tracks, and determines whether or not the observation-tracks are related. The spatial fusion process groups the observations that are associated to the same fused track and outputs the spatial fusion groups to a cluster observation process 62. A Kalman filter tracker 64 uses the cluster observations and a vehicle's ego motion from box 66 to update the fused tracks. The tracked target is then validated at box 68.

In a second thread, the data association processor 58 retrieves the candidate pairs from the observation-track pairs from a particular sensor 22, and then selects the pairs with good matching scores to estimate the position and pose of the sensor 22. The information is sent to a latency estimation processor 70 that uses the synchronizing clock as the time reference to find out the latency in each measurement cycle.

An error model is used to provide sensor correction. A sensor k is mounted at the pose m=(x₀, y₀, θ₀) with respect to the vehicle frame, where θ₀ denotes the orientation of the sensors bore-sight. The measurement of an object is a three-dimensional vector o=(r, θ, υᵣ), where r and θ are the range and azimuth angle measurements in the sensor frame, respectively, and υᵣ denotes the range-rate along the azimuth axis. With random error in measurement, the observation and vehicle frame determined from the vector o becomes a probability distribution whose extent can be characterized by the sensor's error variances. The error variances (σᵣ², σ_{θ}², σᵥ_{ᵣ}²) found in the sensors specification determines the accuracy of the sensor measurement. Besides the variances for the measurements, an extremely large quantity or infinity σᵥ_{ᵣ} is added, corresponding to the unobservable tangent velocity υᵣ. By using a covariance matrix enclosing the component of tangent velocity υᵣ, the sensors 22 are treated with complimentary performance characteristics and different orientations in a unified manner.

The data association processor 58 determines the answer as the given observations oᵢ, for i=1, . . . , N, from one or more of the sensors 22, as to how does the process determine which observations belong together and represent observations of the same target. As discussed herein, the association is determined by computing an association matrix. The (i,j) component of the matrix is the similarity measure that compares the closeness of an observation oᵢ(t) and the predicted observation õⱼ(t) from a previous determined state vector xⱼ(t−1). The Mahalanobis distance is used as:

d(oᵢ,\tilde{e}ⱼ)=(oᵢ−õⱼ)^{T}(Pᵢ+Pⱼ)(oᵢ−õⱼ) (7)

Where, Pᵢ and Pⱼ denote the covariance matrices of the given observation oᵢ(t) and the predicted quantity õⱼ, respectively.

In the proposed system, the assignment logic assigns the observation to the nearest adjacent track, specifically the nearest neighbor approach, i.e., j=arg minⱼ d(oᵢ,õⱼ).

Having established the association that relates the observations oᵢ to predicted observations õⱼ, a key issue is to determine a value of a state vector x(t) that best fits the observed data. To illustrate the formulation and processing flow for the optimization process, the processor 28 uses a weighted least-squares method to group related observations to a clustered observation y in the vehicle frame.

One or more sensors may observe an object and report multiple observations related to the target position x. The unknown fused observation in the vehicle frame is represented by a vector y, determined by a time and variant observation equation g(o,y)=0. With the actual observation o* and the estimated observation y*, the first order approximation of g(o,y) can be written as:

$$\begin{matrix}{{g ( {y}^{*} , {o}^{*} ) + \frac{\partial g}{\partial y} \vert}_{( {y}^{*} , {o}^{*} )} ( y - {y}^{*} ) + \frac{\partial g}{\partial o} \vert}_{( {y}^{*} , {o}^{*} )} ( o - {o}^{*} ) \approx 0 \\ Where , & ( 8 ) \\ {{A = \frac{\partial g}{\partial y} \vert}_{( {y}^{*} , {o}^{*} )} \\ B = \frac{\partial g}{\partial o} \vert}_{( {y}^{*} , {o}^{*} )} & ( 9 ) \\ 𝓁 = - g ( {y}^{*} , {o}^{*} ) and ɛ = - B ( o - {o}^{*} ) & ( 10 )\end{matrix}$$

Equation (8) becomes a linearized form as:

A(y−y*)=l+ε (11)

The residue o−o* gives the difference between the noise-free observation o and the actual observation o*. Hence, the quantity o−o* can be treated as observation noise.

Letting Γₒ denote the observation noise, the covariance matrix (Γε) of the residue ε in equation (11) becomes:

Γ_{ε}=BΓₒB^{T} (12)

It is assumed that a total of K independent observations from K sensors, {oₖ|k=1, . . . , K}, are related to the fused quantity y. Thus, equation (11) can be extended to:

$$( \begin{matrix}{A}_{1} \\ {A}_{2} \\ ⋯ \\ {A}_{K}\end{matrix} ) ( y - {y}^{*} ) = ( \begin{matrix}{𝓁}_{1} \\ {𝓁}_{2} \\ ⋯ \\ {𝓁}_{K}\end{matrix} ) + ( \begin{matrix}{ɛ}_{1} \\ {ɛ}_{2} \\ ⋯ \\ {ɛ}_{K}\end{matrix} ) \qquad ( 13 )$$

By the Gauss-Markov Theorem, obtaining the linear minimum variance estimate of y in equation (13) yields:

$$\hat{y} = {y}^{*} + {( {\sum }_{k = 1}^{K} {A}_{k}^{T} {Γ}_{ɛ k}^{- 1} {A}_{k} )}^{- 1} {\sum }_{k = 1}^{K} {A}_{k}^{T} {Γ}_{ɛ k}^{- 1} {𝓁}_{k} \qquad ( 14 )$$

The process of the invention assumes that the target executes a maneuver under constant speed along a circular path. This type of motion is common in ground vehicle traffic. FIG. 5 shows a plant model of the dynamics of the motion of a subject vehicle 80 and a target vehicle 82. As discussed above, the measurement y in the vehicle frame includes xₒ,yₒ,υₓₒ and υ_{yo}. The target vehicle dynamic state is represented by x=(x,y,ψ,ω,υ),where the quantities x,y and ψ denote the pose of the target vehicle 82 and ω and υ denote the target vehicle's kinematic state.

The dynamic evolution of the target state x′=f(x,u_{H}) is given by:

x′=x+(υ cos ψ+yω_{H}−υ_{xH})ΔT+ΔT cos ψ∈₂ (15)

y′=y+(υ sin ψ−xω_{H}−υ_{yH})ΔT+ΔT sin ψ∈₂ (16)

ψ′=ψ+(ω−ω_{H})ΔT+ΔT∈₁ (17)

ω′=ω+∈₁ (18)

υ′=υ+∈₂ (19)

The observation quantity y=h(x, u_{H}) is given by:

xₒ=x+ν₁ (20)

yₒ=y+ν₂ (21)

υₓₒ=υ cos ψ+yω_{H}−υ_{xH}+ν₃ (22)

Where ∈₁ and ∈₂ are two zero-mean white random processes with Gaussian distribution, and νⱼ, for j=1,2,3, are measurements noises for modeled by zero-mean white Gaussian random processes.

After establishing the observation equations that relate a state vector to predicted observations, and also the motion equations for the dynamic system, a version of an Extended Kalman filter (EKF) can be used as the tracking algorithm.

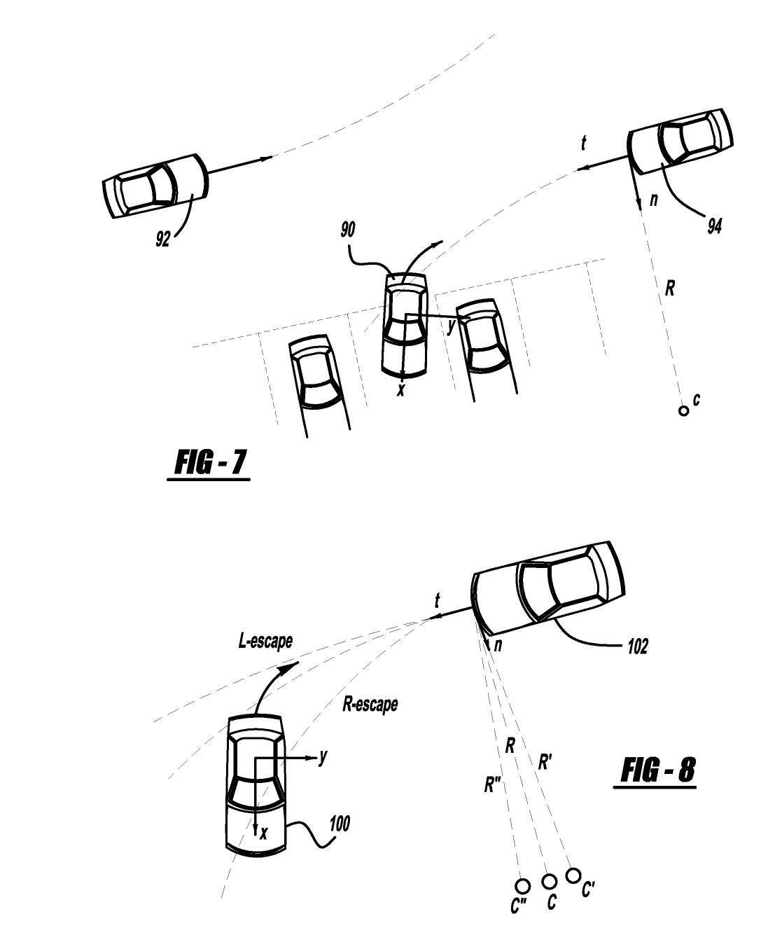

The function of the target selection processor 32 is to select the objects that are in the projected path of the subject vehicle 10. FIG. 6 illustrates a subject vehicle 90 backing out of a parking space, where two target vehicles 92 and 94 are moving in an adverse direction to each other and perpendicular to the subject vehicle's heading. FIG. 7 shows the scenario of FIG. 6 in the subject vehicle's coordinate system. The paths of the target vehicles 92 and 94 become circular because of the turning of the subject vehicle 90. The target vehicle 94 is in a divergence path. Meanwhile, the target vehicle 92 is in a converging path and should be selected since its projected path penetrates the subject vehicle's contour. The decision making criteria can be provided mathematically as follows.

Let the object map from the object fusion be {xᵢ|i=1, . . . , N}, and each object has the components of x is the longitudinal displacement, y is the lateral displacement, φ is the vehicle's heading, ω is the vehicle's angular velocity with respect to the world coordinates, and υ is the vehicle's velocity with respect to the world coordinates. The relative velocities with respect to the vehicle frame become:

υₓᵣ=υ cos ψ+yω_{H}−υ_{xH} (23)

υ_{yx}=υ sin ψ−xω_{H}−υ_{yH} (24)

ωᵣ=ω−ω_{H} (25)

Where υ_{xH},ν_{yH} and ω_{H} are the components of the vehicle motion vector u_{H}.

As shown in FIG. 7, under the assumption of the constant velocity for both the subject vehicle 90 and the target vehicles 92 and 94, the combined projected path is circular. By letting the relative velocity vector be ν=(υᵣₓ,υ_{ry}), the radius of the path can be computed as, if: ωᵣ=0:

$$R = \{ \begin{matrix}\frac{‖ v ‖}{{ω}_{r}} , if {ω}_{r} \neq 0 \\ 10 , 000 otherwise\end{matrix} \qquad ( 26 )$$

The unit vector in the target vehicle's heading is denoted as

$$t = \frac{v}{‖ v ‖} .$$

Then, the normal vector n of the target vehicle's path is computed as:

n=rot(π/2) (27)

Where rot(π/2) is a rotation matrix, (i.e.,

$$rot ( π / 2 ) = ( \begin{matrix}0 & - 1 \\ 1 & 0\end{matrix} ) .$$

Thus, the center of the circular path can be written as:

c=Rn+r (28)

Where r denotes the position vector of the target (x,y).

By letting the known locations of the four corners in the contour of the subject vehicle 90 be represented as dₖ, for k=1,2,3,4, the quantity lₖ can be calculated that reflects whether the corners are enclosed by the circular path:

$${l}_{k} = \{ \begin{matrix}1 & ‖ c - {d}_{k} ‖ < R \\ - 1 & Otherwise\end{matrix} \qquad ( 29 )$$

for k=1, 2, 3, 4.

Therefore, the decision rule of the selection process is to select the object if, and only if, the four quantities lₖ for k=1,2,3,4 have different signs. This is intuitive as shown in FIGS. 6 and 7. The object path penetrates the subject vehicle's contour if, and only if, the four corners lie in different sides of the path.

Not all of the targets pose a threat to the subject vehicle 10. In the threat assessment processor 34, action is only activated in the following two conditions. A warning is provided if the driver of the target vehicle 12 would have to execute a maneuver that satisfies the warning criteria for either having to brake above a threshold, for example, 0.1 g, or swerve with a lateral acceleration above a predetermined threshold, such as 0.05 g, to avoid a collision. Automatic braking is provided if the driver of the target vehicle 12 would have to execute a maneuver that satisfies the automatic braking criteria for either having to brake above a threshold, such as 0.3 g, or swerve with a lateral acceleration above a predetermined threshold, such as 0.15 g, to avoid a collision with the subject vehicle 10.

The required longitudinal braking a_{req}, defined as the minimum deceleration to stop the vehicle 12 before impacting the subject vehicle 10, can be calculated as:

$${a}_{req} = \frac{- {‖ v ‖}^{2}}{2 ‖ r ‖ - ‖ v ‖ {t}_{R}} \qquad ( 30 )$$

Where t_{R} denotes the driver's reactive delay, such as 0.2 seconds.

The lateral swerving maneuver, denoted as the lateral acceleration a_{yT}, changes the curvature of the projected object path by changing the yaw rate of the target vehicle 12, i.e.,

$${ω}_{r}^{′} = {ω}_{r} \pm \frac{{a}_{yT}}{‖ v ‖} .$$

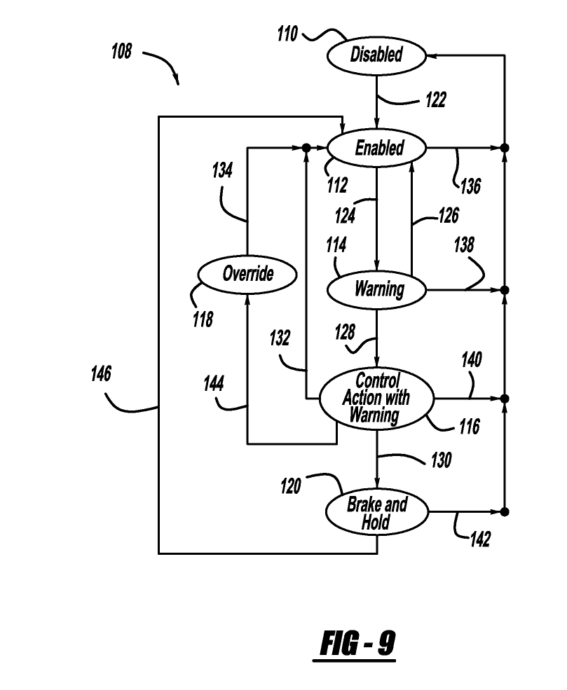

FIG. 8 shows two escape paths by swerving between a subject vehicle 100 and a target vehicle 102. The radius R″ and the center c″ denote the left escape path and the radius R′ and the center c′ denote the right escape path. A similar method is used to determine whether the swerving path penetrates the contour of the subject vehicle 100.

FIG. 9 is a state transition diagram 108 showing transitions between various states in the RCTCA system of the invention. The RCTCA system has six states, namely a disabled state 110 where the detection, information, warning and control functionality of the RCTCA system are disabled. The system also includes an enabled state 112 where an enabling switch is on, all enabling conditions are met, and the system is currently monitoring the rear cross-traffic situations. The system also includes a warning state 114 that warns the driver of a potential mild threat. The system also includes a control action with warning state 116 where the system has detected an imminent collision and has initiated braking action. The system also has an override state 118 where the vehicle driver has overridden the system temporarily preventing it from carrying out its detection, information, warning and control functionality. The system also includes a brake and hold state 120 where the system issues hold commands to the automatic brake system when the vehicle comes to a complete stop.

The following transitions are shown in the diagram 108. Line 122 represents a first transition where all of the enabling conditions are true and the enabling switch is on. The enabling conditions include the subject vehicle's PRNDL is set to reverse, the subject vehicle speed is above a minimum speed and below a maximum speed, and the sensors are operating in the normal mode.

Transition line 124 represents a mild conflict condition. The system provides a warning to the driver if a rear cross-traffic object has been detected as a potential threat, has been classified as a mild conflict and the enabling switch is on.

Transition line 126 represents a threat that ceases to exist. The warning is cancelled if the situation changes such that the mild conflict condition ceases to exist or the enabling switch is set to off.

Transition line 128 represents an imminent conflict condition. The system activates the brake of the vehicle if a situation with a rear cross-traffic object has been detected as an imminent threat and the enabling switch is on.

Transition line 130 represents a vehicle halt transition. The system holds the subject vehicle 10 until the driver resumes control of the vehicle 10.

Transition line 132 represents a threat ceases to exist transition. The brake activation is cancelled if the situation changes so that the conflict condition ceases to exist or the enabling switch is set to off.

Transition line 134 represents an override timeout and override condition not met transition. The system goes to the enabled state 112 when the system assumes the driver has released the control to the automatic system and a specific period of time has passed. The release occurs if the throttle pedal is released.

Transition lines 136, 138, 140 and 142 represents enabling conditions not met transitions. The enabling conditions for the transition 122 are not met, thus the system goes to the disabled stage 110.

Transition line 144 represents an override condition transition. The system assumes that the driver has reacquired control of the subject vehicle if any of the following conditions are true. The driver sets the enable switch to off, the driver provides a throttle input, or the driver provides a vehicle braking request greater than the system.

Transition line 146 represents a regain condition transition and provides the same conditions as the transition line 144.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for providing rear cross-traffic collision avoidance for a subject vehicle, said system comprising:
object detection sensors for detecting objects and providing object sensor signals;
vehicle sensors for sensing vehicle turning and providing vehicle sensor signals;
an object tracking and classification processor responsive to the object sensor signals, said tracking and classification processor identifying and tracking objects that potentially may interfere with the subject vehicle and providing target identification and tracking signals;
a host vehicle path prediction processor responsive to the vehicle sensor signals, said host vehicle path prediction processor providing path curvature signals indicating the curvature of a path of the subject vehicle;
a target selection processor responsive to the target identification and tracking signals and the path curvature signals, said target selection processor identifying potential objects in the tracking and classification signals that may be in a collision path with the subject vehicle, and providing potential objects signals; and
a threat assessment processor responsive to the potential objects signal and determining whether action should be taken to avoid a collision with an object.

2. The system according to claim 1 wherein the threat assessment processor determines whether a potential collision with an object is a minor potential collision or an imminent collision.

3. The system according to claim 2 wherein the threat assessment processor provides a visual, auditory and/or sensory warning to the subject vehicle driver if the threat assessment processor determines that the potential collision is a minor potential collision.

4. The system according to claim 3 wherein the threat assessment processor provides the warning if the object would have to execute a maneuver that would require the object to apply braking above a predetermined threshold or swerve with a lateral acceleration above a predetermined threshold.

5. The system according to claim 2 wherein the threat assessment processor causes the vehicle brakes to be applied if the threat assessment processor determines that the potential collision is an imminent collision.

6. The system according to claim 5 wherein the threat assessment processor causes the vehicle brakes to be applied if the object would have to brake above a predetermined threshold or swerve with a lateral acceleration above a predetermined threshold to avoid a collision with the subject vehicle.

7. The system according to claim 1 wherein the object detection sensors are selected from the group consisting of radar sensors and cameras.

8. The system according to claim 1 wherein the vehicle sensors are selected from the group consisting of steering wheel angle sensors and yaw rate sensors.

9. The system according to claim 1 wherein the host vehicle path prediction processor uses a bicycle model to determine the curvature of the path of the subject vehicle.

10. The system according to claim 1 wherein the object tracking classification processor uses a Kalman filter tracker to fuse object tracks.

11. The system according to claim 1 wherein the object detection sensors are positioned at a rear of the subject vehicle and the system is a cross-traffic collision avoidance system so as to prevent the subject vehicle from colliding with another vehicle when the subject vehicle backs into cross-traffic.

12. A system for providing rear cross-traffic collision avoidance between a subject vehicle backing into cross-traffic and target vehicles traveling in the cross-traffic, said system comprising:
object detection sensors for detecting the target vehicles in the cross-traffic as the subject vehicle backs up;
vehicle sensors for detecting turning of the subject vehicle; and
a controller for determining a path curvature of the subject vehicle and identifying and tracking target vehicles that potentially may interfere with the subject vehicle, said controller causing certain actions to be taken if a potential collision with one of the target vehicles is determined.

13. The system according to claim 12 wherein the controller determines whether the potential collision with one of the target vehicles is a minor potential collision or an imminent collision.

14. The system according to claim 13 wherein the controller causes a warning to the subject vehicle driver if the potential collision is a mild potential collision and provides automatic braking if the potential collision is an imminent collision.

15. The system according to claim 12 wherein the object detection sensors are selected from the group consisting of radar sensors and cameras.

16. The system according to claim 12 wherein the vehicle sensors are selected from the group consisting of steering wheel angle sensors and yaw rate sensors.

17. The system according to claim 12 wherein the controller uses a bicycle model to determine the curvature of the path of the subject vehicle.

18. The system according to claim 12 wherein the controller uses a Kalman filter tracker to fuse object tracks.

19. A method for providing rear cross-traffic collision avoidance between a subject vehicle backing into cross-traffic and target vehicles traveling in the cross-traffic, said method comprising:
detecting the target vehicles in the cross-traffic;
detecting turning of the subject vehicle as the subject vehicle backs into the cross-traffic;
identifying and tracking the target vehicles in the cross-traffic that may potentially interfere with the subject vehicle;
determining a path curvature of the subject vehicle; and
causing certain actions to be taken if a potential collision with one of the target vehicles is determined.

20. The method according to claim 19 wherein causing certain actions to be taken includes providing a vehicle warning if the potential collision is considered minor and providing vehicle braking if the potential collision is determined to be imminent.
